(19) United States
(12) Patent Application Publication
(10) Pub. No.: US 2016/0267231 A1
(43) Pub. Date: Sep. 15, 2016

(54) METHOD AND DEVICE FOR DETERMINING POTENTIAL RISK OF AN INSURANCE CLAIM ON AN INSURER

(71) Applicants: Abhishek GUNJAN, Gaya (IN); Sreevidya KHATRAVATH, Hyderabad (IN)

(72) Inventors: Abhishek GUNJAN, Gaya (IN); Sreevidya KHATRAVATH, Hyderabad (IN)

(73) Assignee: Wipro Limited, Bangalore (IN)

(21) Appl. No.: 14/746,509

(22) Filed: Jun. 22, 2015

(30) Foreign Application Priority Data
Mar. 11, 2015 (IN) 1204/CHE/2015

(51) Int. Cl. G06F 19/00

(52) U.S. Cl. CPC G06F 19/328

(57) ABSTRACT

The present disclosure relates to a method and a device for determining potential risk of an insurance claim on an insuree by an insurer. In one embodiment, a plurality of insurance claims and data associated with the insurance claims is received and classified into segments. Upon classifying into segments, risk associated with each segment is determined based on which financial impact is predicted. On predicting the financial impact, the probability of availing an insurance policy by a potential insuree is also predicted. By profiling the customers, segments favorable for customers is determined. Further, prediction and forecast of high risk prone customer segments provides better understanding of risk prone customers and enables the companies to take necessary action on the risk prone customers. Further, the method enables automatic calculation of debts associated with the risk prone customers and provides better understanding of policies prone to risk based on debt calculation.

### PRIORITY CLAIM

This U.S. patent application claims priority under 35 U.S.C. §119 to Indian Application No. 1204/CHE/2015, filed on Mar. 11, 2015. The aforementioned application is incorporated herein by reference in its entirety.

### FIELD OF THE DISCLOSURE

The present subject matter is related, in general to risk management, and more particularly, but not exclusively to method and device for determining potential risk of an insurance claim on an insuree by an insurer.

### BACKGROUND

Generally, insurance companies suffer from huge loss when their customers are out of work due to several reasons. Core functional issues faced by the insurance companies include improper payments associated with fraud, lack of meaningful analytics, and lack of coordinated risk management approach. Current systems available for risk determination and management with respect to insurance claims do not have a capability to compute potential Risk and debt caused due to medical and behavior condition of customer leading to multiple claims and loss of revenue.

Existing systems works on parameters like age, gender, policy type, policy maturity status, industry type, etc. only and does not consider other important parameters for e.g. type of disease, severity of disease, behaviour type, behaviour level, etc. Thus, it does not have the ability to compute liabilities based on behaviour and medical condition of the customers. So, the insurance companies are unable to understand know how about the customer base and predict/forecast liabilities well before in advance. Also, since the existing systems lack the ability of detecting risk prone segments, they are unable to drill down to perform root cause analysis of the risk. Further, the existing systems are unable to perform real-time debt calculation.

Therefore, there is a need for method and device for determining potential risk of an insurance claim on an insuree by an insurer and overcoming the disadvantages and limitations of the existing systems.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method of determining potential risk of an insurance claim on an insuree by an insurer. The method comprises the steps of receiving a plurality of insurance claims associated with a plurality of insurees. The method further comprising classifying the plurality of insurance claims into a plurality of segments based on an insuree profile associated with each of the plurality of insurees, wherein the insuree profile comprises at least medical data and behavioral data associated with each of the plurality of insurees. Upon classifying the insurance claims, the method comprising determining risk associated with the plurality of segments based on at least the medical data and behavioral data of the plurality of insurees.

Further, the present disclosure relates to a device for determining potential risk of an insurance claim on an insuree by an insurer. The device comprises a processor and a memory communicatively coupled to the processor, wherein the memory stores processor-executable instructions, which, on execution, cause the processor to. The processor is furthermore configured to receive a plurality of insurance claims associated with a plurality of insurees. Upon receiving the insurance claims, the processor classifies the plurality of insurance claims into a plurality of segments based on an insuree profile associated with each of the plurality of insurees, wherein the insuree profile comprises medical data and behavioral data of an insuree. The processor further determines a risk factor associated with the one or more segments based at least on the medical data and behavioral data of the plurality of insurees.

Furthermore, the present disclosure relates to a non-transitory computer readable medium including instructions stored thereon that when processed by at least one processor cause a system to perform the act of. Further, the instructions cause the processor to receive a plurality of insurance claims associated with a plurality of insurees. Upon receiving the insurance claims, the processor classifies the plurality of insurance claims into a plurality of segments based on an insuree profile associated with each of the plurality of insurees, wherein the insuree profile comprises medical data and behavioral data of an insuree. The processor further determines a risk factor associated with the one or more segments based at least on the medical data and behavioral data of the plurality of insurees.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a block diagram of an exemplary risk determination device for determining potential risk of an insurance claim on an insuree by an insurer in accordance with some embodiments of the present disclosure;

FIG. 2a illustrates an exemplary block diagram of a data adapter in accordance with some embodiments of the present disclosure;

FIG. 2b illustrates an exemplary block diagram of a configuration manager of the data adapter of FIG. 2a in accordance with some embodiments of the present disclosure;

FIG. 2c illustrates an exemplary block diagram of analytics module in accordance with some embodiments of the present disclosure;

FIG. 2d illustrates an exemplary block diagram of otter module in accordance with some embodiments of the present disclosure;

FIG. 3 illustrates a flowchart of an exemplary method of determining potential risk of an insurance claim on an insuree by an insurer in accordance with some embodiments of the present disclosure;

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method and a device for determining potential risk of an insurance claim on an insuree by an insurer. In one embodiment, a plurality of insurance claims and data associated with the insurance claims is received and classified into segments. Upon classifying into segments, risk associated with each segment is determined based on which financial impact is predicted. On predicting the financial impact, the probability of availing an insurance policy by a potential insuree is also predicted. By profiling the customers, segments favorable for customers are determined. Further, prediction and forecast of high risk prone customer segments provides better understanding of risk prone customers and enables the companies to take necessary action on the risk prone customers. Further, the method enables automatic calculation of debts associated with the risk prone customers and provides better understanding of policies prone to risk based on debt calculation.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

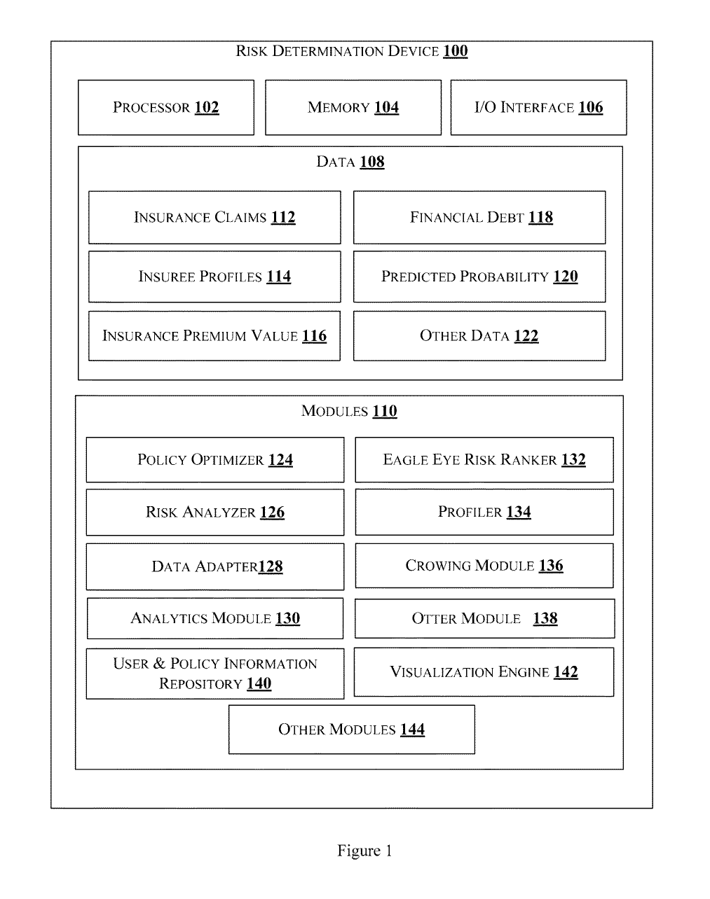

FIG. 1 illustrates a block diagram of an exemplary risk determination device for determining potential risk of an insurance claim on an insuree by an insurer in accordance with some embodiments of the present disclosure.

As illustrated, the risk determination device 100 (hereinafter referred to as device 100) comprises one or more components configured to determine potential risk associated with an insurance claim on an insuree by an insurer. In one embodiment, the exemplary device 100 comprises a central processing unit (“CPU” or “processor”) 102, the memory 104 and an I/O interface 106. The I/O interface 106 is coupled with the processor 102 and an I/O device. The I/O device is configured to receive inputs via the I/O interface 106 and transmit outputs for displaying in the I/O device via the I/O interface 106.

The device 100 further comprises data 108 and modules 110. In one implementation, the data 108 and the modules 110 may be stored within the memory 104. In one example, the data 108 may include plurality of insurance claims 112, plurality of insuree profiles 114, insurance premium value 116, financial debt 118, and predicted probability 120. In one embodiment, the data 110 may be stored in the memory 104 in the form of various data structures. Additionally, the aforementioned data can be organized using data models, such as relational or hierarchical data models. The other data 122 may be also referred to as reference repository for storing recommended implementation approaches as reference data. The other data 122 may also store data, including temporary data and temporary files, generated by the modules 110 for performing the various functions of the device 100.

The modules 110 may include, for example, policy optimizer 124, risk analyzer 126, data adapter 128, an analytics module 130, eagle eye risk ranker 133, profiler 134, crowing module 136, otter module 138, user & policy information repository module 140 and visualization engine 142. The modules 110 may also comprise other modules 144 to perform various miscellaneous functionalities of the device 100. It will be appreciated that such aforementioned modules may be represented as a single module or a combination of different modules. The modules 110 may be implemented in the form of software, hardware and or firmware.

The device 100 determines potential risk of an insurance claim based on medical and behavioral data of customer or insuree. In one embodiment, the policy optimizer 124 provides information of the insuree including medical and behavioral information, type of policy availed and number of times the insuree has availed the claim. The policy optimizer 124 also provides information on claim rejection, delay in approving the claim, family medical information, disease information, working environment and claim rejection of an insuree and so on. The risk analyzer 126 receives such information about the insuree from the policy optimizer 124 for performing risk analysis.

In one embodiment, the risk analyzer 126 comprises one or more modules comprising the data adapter 128, the analytics module 130, the eagle eye risk ranker 133, the profiler 134, the crowing module 136, the otter module 138, the user & policy information repository module 140 and the visualization engine 142. The data adapter 128 connects with one or more databases using one or more data connectors, retrieves data from the connected databases and provides the retrieved data in one or more predefined file formats. The data adapter 128 also enables necessary configuration setting related to rules for segmentation and threshold value for segmentation.

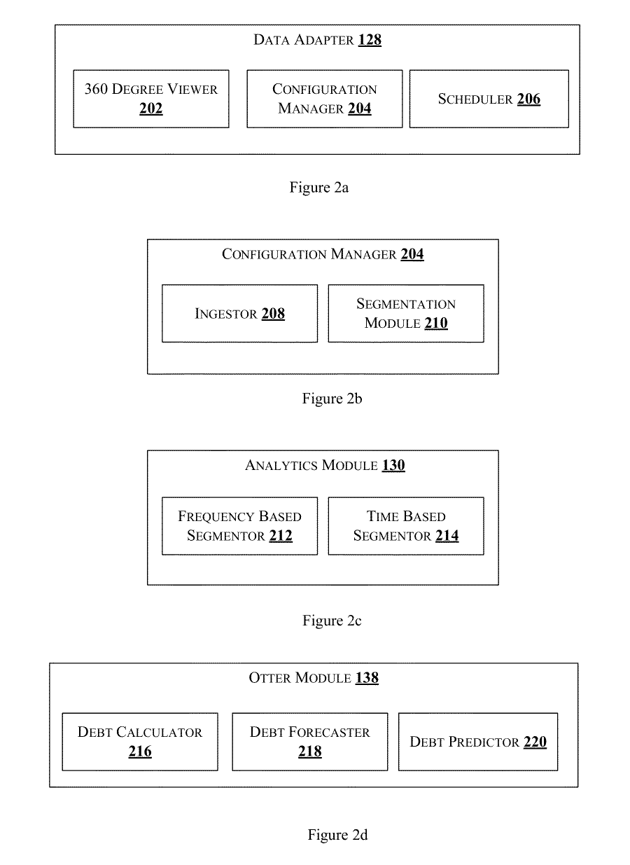

As illustrated in FIG. 2a, the data adapter 128 comprises a 360 degree viewer 202, a configuration manager 204 and a scheduler 206. The 360 degree viewer 202 is configured to perform risk modeling by reading 360 degree view of the customer/insuree information. For example, the 360 degree view of the customer information includes user information, medical information, behavior information, policy information, claim information, family history information and so on. In one implementation, user information may include all necessary information related to the user/insuree for example, age, and gender, kind of industry the user or customer is employed and so on. The user information may also include enriched user information from social media including interest groups and other related social information about the user. The medical information may include all types of diseases the user is suffering from and all information relating to disease such as medicines, doctor prescriptions, medical reports and future prediction of stages of user's disease severity, recovery period of disease and so on. The behavior information includes features and attributes of the user that symbolizes a particular behavior of the insuree. The behavior information may include insights on different details provided by the insuree to avail a policy having authenticated or unauthenticated claims and complete behavior information of the insuree from the initial processing of claim.

The policy information include all the information about different insurance policies offered, user information opting different policies, duration of policy, terms and conditions of the policy, user information availing benefits of policy, financial information about the policy etc. Claim information may include information specific to the claim such as claimed financial assistance by user from the policy, disease claimed, approved and pending claims, reasons for pending claims, claims which are likely to be approved, etc. The family history information includes information of family medical disease history, diseases which impact through generations, severity of disease in other family members, diseases which are probable to affect the user and so on. The 360 degree viewer 202 is further configured to process data related to kind of policy taken by the customer and frequency of availing the benefit of the claims.

The configuration manager 204 enables the user to configure different data sources and the data format to ingest the data into the system automatically. The configuration manager 204 also comprises one or more connectors to read data from multiple data formats. Further, the configuration manager 204 comprises one or more database connectors to read data from multiple databases or data sources. The configuration manager 204 is further configured to set one or more parameters and threshold values to the one or more attributes used for segmentation based on which risk modeling is performed. In one embodiment, the configuration manager 204, as illustrated in FIG. 2b, comprises at least an ingestor 208 and a scheduler 210.

The ingestor 208 is configured to process the policy information that are in different formats such as digital, hand written, pdf, doc, and so on, convert the processed policy information to one user defined format and store the formatted information in the user & policy information repository 140. All the digitized forms about policies such as duration of policy, terms of policy, financial info, etc. are stored and directly accessed from the user & policy information repository 140. The ingestor 208 is further configured to convert the images of proves submitted by the insuree to digitized form by any character recognition mechanisms like for example, OCR. The scheduler 210 receives the 360 degree view customer information from the 360 degree viewer 202 and segments the received information into one or more segments or categories including financial information, user information, medical information of users, policies opted by the user and so on.

The scheduler 206 receives information on all the users, claim approval or pending status, policy details and identifies the missing information about the policy, claim and reasons behind pending claims, financial information and so on. The scheduler 206 enables batch processing by performing multiple scheduling related operations like cube building, predictive model building, forecasting model building, reporting, auditing, etc. the scheduler 206 is also configured to generate one or more queries that enables user to dynamically build cubes and store for future use. The scheduler 206 also enables generation of one or more trending reports and one or more priority shift reports for a predetermined time period. The scheduler 206 is further configured to learn incorrect Risk Ranking and undertakes required measures as the time graduates. In one example, the scheduler 206 determines how frequently a cube or dimension changes and based on the determination, the scheduler 206 determines the priority of scheduling. The scheduler 206 further generates one or more analytical reports representing unnecessary cubes based on usage and recommends admin to take measures in memory cleanup.

In one embodiment, the analytics module 130 analyzes the data ingested by the data adapter 128. The analytics module 130 analyzes the data based on frequency and time and generates one or more segments of data having one or more dimensions set based on the analysis. For example, if the analysis is made based on frequency of availing the policy based on age, gender and location, then the analytics module 130 generates a smaller dimension set based segment comprising three dimensions including age, gender and location. If the analysis is made based on the age, gender, location, work industry, disease severity, psychological behavior, intensity of behavior type, family history, presence of disease in family tree, etc., then the analytics module 130 generates a larger dimensions set based segment. Dimensions for the larger dimensions set based segment include age, gender, location, work industry, disease severity, psychological behavior, intensity of behavior type, family history, presence of disease in family tree, etc. The analytics module 130 is further configured to determine significant frequency based and time based segments for further processing.

As illustrated in FIG. 2c, the analytics module 130 comprises at least a frequency based segmentor 212 and a time based segmentor 214. In one embodiment, the frequency based segmentor 212 segments the plurality of claims based on the number or frequency of claims availed by age based segmentation, gender based segmentation, work type segmentation, disease based, financial information based, policy type etc. In another embodiment, the frequency based segmentor 212 segments the plurality of claims based on different attributes including age, gender, and work or based on predefined larger dimension set.

The time based segmentor 214 segments the plurality of claims based on the duration for which the claim was availed with respect to the policy type on multiple parameters like age, gender, work, type and so on. Upon segmentation, the time based segmentor 214 classifies the plurality of claims into two categories, for example, first category comprising claims that are taken for longer duration and second category comprising claims that are taken for shorter duration.

The Eagle Eye Risk Ranker 132 (hereinafter referred to as EERR 132) is configured to determine the vulnerability level of the frequency based and time based segments. In one embodiment, the EERR 132 receives the frequency based and time based segments from the analytics module 130 and computes one or more high risk prone segments and degree of risk associated with a particular high risk prone segment. The EERR 132 computes the one or more high risk prone segments by adding dollar value to the frequency based and time based segments and determines the degree of risk associated with each frequency based and time based segments. Upon determining the degree of risk, the EERR 132 creates a Risk stack by ranking the segments in the order of risk degree. The EERR 132 also enables addition or removal of segments and real time creation of the risk stack upon addition or removal.

The profiler 134 creates a segment based model and performs profiling of the customers based on the segment based model thus created. In one embodiment, the profiler 134 creates the segment based model based on the risk determined by the EERR 132. Upon creating the segment based model, the profiler 134 performs profiling of the customers. In one aspect, the profiler 134 creates one or more profiles of the customers based on segment and customer information. The profiler 134 also enables using multiple dimensions including medical, behavior, age, gender and so on and forecast profiling based on change in the multiple dimensions. In one exemplary scenario, when a new policy is provided to a customer, the profiler 132 performs real time profiling of the prospect customer and determines the degree of risk associated with the prospect customer. The profiler 134 further determines the premium value based on the degree of risk determined for the prospect customer. Further, the profiler 134 enables comparison of one or more profiles based on different segments and determines one or more risk prone profiles based on comparison. The profiler 134 also determines one or more policy types that are favorable for one or more segments or customers based on the associated risk.

The crowing engine 136 predicts or forecasts the set of customers who are likely to avail the claim so as to provide a clear view of the financials to the insurer to determine the financial reserve in advance. In one embodiment, the crowing engine 136 creates a predictive model based on the frequency based and time based segments determined by the analytics module 130, the profiling of the customers by the EERR 132 and one or more parameters including age, gender, disease, behaviour, work industry, type of work, etc. Based on the predictive model thus created, the crowing engine 136 forecasts as to whether the customer is availing the claim or not and determines the list of customers who are likely to avail the claim. Further, the crowing engine 136 also determines the actual number of days for which the customer is likely to avail the claim based on already approved claim duration. Based on the predictive model and the forecast model along with actual number of days, the otter module 138 computes the debt and continuously monitors the risk and debit in a balance sheet. The crowing engine 136 also determines the areas of improvement where the debit index can be minimal.

The otter module 138 predicts or forecast debit on the claims been availed or is likely to be availed by the customers. In one embodiment, the otter module 138 determines the debt on the claims that are availed or likely to be availed based on the prediction or forecasting model created by the crowing engine 136. The otter module 138 also generates real time account summary reports of each account of the customers. The otter module 138, as illustrated in FIG. 2d, comprises at least a debt calculator 216, a debt forecaster 218 and a debt predictor 220.

The debt calculator 216 analyses a plurality of authenticated genuine policies and a plurality of present authenticated risk prone policies and determines actual debt incurring to the insurer. In one embodiment, the debt calculator 216 compares the plurality of authenticated genuine policies that are profitable to the insurer with the plurality of present authenticated risk prone policies that are at loss. Upon comparison, the debt calculator 216 determines the actual debt to the insurer based on the availed policies that are risk prone and based on the determination of the financial returns by the insuree of a policy being lesser than the expected return.

The debt forecaster 218 forecast and generates a report on the financial impact of the insurance company if the risk prone policies are approved. The debt forecaster 218 forecasts the debt based on one or more parameters including likelihood of the insuree to be out of work in future, likelihood of availing the claim benefits of policy which will financially impact to the insurance company, duration for which the insuree is availing the benefits of claimed policy and resulting financial impact to the insurance company calculated using causal analysis on the disease and behavior data of insuree and so on.

The debt predictor 220 predicts the feasible out of work scenarios which will influence the debts to the insurance company. In one embodiment, the debt predictor 220 predicts the duration of claim of risk prone insuree's, and determines parameters including time out of work, and financial assistance time span from the insurance company. Upon prediction, the debt predictor 220 determines the debt involved based on the prediction and the dollar value involved in the claim.

The visualization engine 142 enables real time visualization of end-to-end life cycle and process flow of the claim. In one embodiment, the visualization engine 142 enables claim processing and analyzes the customer segment based on one or more dimensions including disease, behavior and so on. The visualization engine 142 also validates the accuracy of the prediction and forecasting model for tuning and rebuilding the model upon detecting any accuracy error. Further, the visualization engine 142 performs claim prediction and forecasting and claim analysis based on the customer's historical data.

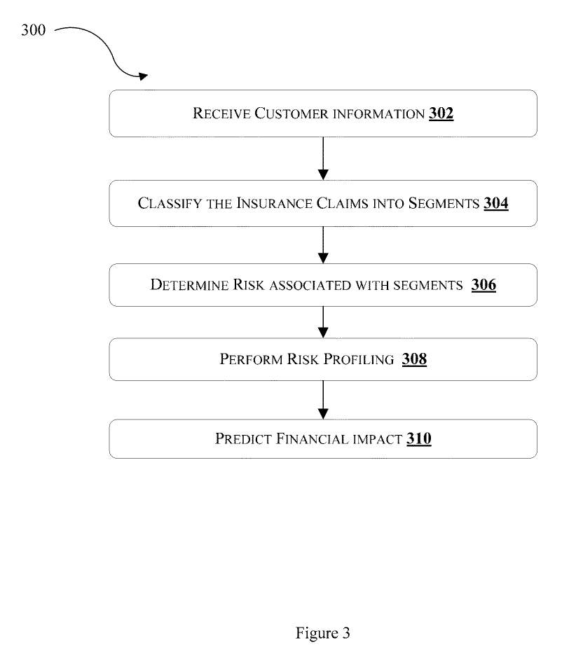

FIG. 3 illustrates a flowchart of method of determining potential risk of an insurance claim on an insuree by an insurer in accordance with an embodiment of the present disclosure.

As illustrated in FIG. 3, the method 300 comprises one or more blocks implemented by the processor 102 of the risk determination device 100 for determining potential risk of an insurance claim on an insuree by an insurer. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

At block 302, receive customer information and insurance claims. In one embodiment, the policy optimizer 124 provides information of the insuree including medical and behavioral information, type of policy availed and number of times the insuree has availed the claim. The policy optimizer 124 also provides information on claim rejection, delay in approving the claim, family medical information, disease information, working environment and claim rejection of an insuree and so on. The risk analyzer 126 receives such information about the insuree from the policy optimizer 124 for performing risk analysis.

The 360 degree viewer 202 of the risk analyzer 126 is configured to receive 360 degree view of the customer/insuree information. For example, the 360 degree view of the customer information includes user information, medical information, behavior information, policy information, claim information, family history information and so on. In one implementation, user information may include all necessary information related to the user/insuree for example, age, and gender, kind of industry the user or customer is employed and so on. The user information may also include enriched user information from social media including interest groups and other related social information about the user. The medical information may include all types of diseases the user is suffering from and all information relating to disease such as medicines, doctor prescriptions, medical reports and future prediction of stages of user's disease severity, recovery period of disease and so on. The behavior information includes features and attributes of the user that symbolizes a particular behavior of the insuree. The behavior information may include insights on different details provided by the insuree to avail a policy having authenticated or unauthenticated claims and complete behavior information of the insuree from the initial processing of claim.

The policy information include all the information about different insurance policies offered, user information opting different policies, duration of policy, terms and conditions of the policy, user information availing benefits of policy, financial information about the policy etc. Claim information may include information specific to the claim such as claimed financial assistance by user from the policy, disease claimed, approved and pending claims, reasons for pending claims, claims which are likely to be approved, etc. The family history information includes information of family medical disease history, diseases which impact through generations, severity of disease in other family members, diseases which are probable to affect the user and so on. The 360 degree viewer 202 is further configured to process data related to kind of policy taken by the customer and frequency of availing the benefit of the claims.

The configuration manager 204 enables the user to configure different data sources and the data format to ingest the 360 degree information into the system automatically. The configuration manager 204 also comprises one or more connectors to read data from multiple data formats. Further, the configuration manager 204 comprises one or more database connectors to read data from multiple databases or data sources. The ingestor 208 is configured to process the policy information that are in different formats such as digital, hand written, pdf, doc, and so on, convert the processed policy information to one user defined format and store the formatted information in the user & policy information repository 140. All the digitized forms about policies such as duration of policy, terms of policy, financial info, etc. are stored and directly accessed from the user & policy information repository 140. The ingestor 208 is further configured to convert the images of proves submitted by the insuree to digitized form by any character recognition mechanisms like for example, OCR. The scheduler 210 receives the 360 degree view customer information from the 360 degree viewer 202 and segments the received information into one or more segments or categories including financial information, user information, medical information of users, policies opted by the user and so on.

The scheduler 206 receives information on all the users, claim approval or pending status, policy details and identifies the missing information about the policy, claim and reasons behind pending claims, financial information and so on. The scheduler 206 enables batch processing by performing multiple scheduling related operations like cube building, predictive model building, forecasting model building, reporting, auditing, etc. the scheduler 206 is also configured to generate one or more queries that enables user to dynamically build cubes and store for future use. The scheduler 206 also enables generation of one or more trending reports and one or more priority shift reports for a predetermined time period. The scheduler 206 is further configured to learn incorrect Risk Ranking and undertakes required measures as the time graduates. In one example, the scheduler 206 determines how frequently a cube or dimension changes and based on the determination, the scheduler 206 determines the priority of scheduling. The scheduler 206 further generates one or more analytical reports representing unnecessary cubes based on usage and recommends admin to take measures in memory cleanup.

At block 304, classify the insurance claims into segments. In one embodiment, analytics module 130 analyzes the data ingested by the data adapter 128. The analytics module 130 analyzes the data based on frequency and time and generates one or more segments of data having one or more dimensions set based on the analysis. For example, if the analysis is made based on frequency of availing the policy based on age, gender and location, then the analytics module 130 generates a smaller dimension set based segment comprising three dimensions including age, gender and location. If the analysis is made based on the age, gender, location, work industry, disease severity, psychological behavior, intensity of behavior type, family history, presence of disease in family tree, etc., then the analytics module 130 generates a larger dimensions set based segment. Dimensions for the larger dimensions set based segment include age, gender, location, work industry, disease severity, psychological behavior, intensity of behavior type, family history, presence of disease in family tree, etc. The analytics module 130 is further configured to determine significant frequency based and time based segments for further processing.

In one embodiment, the frequency based segmentor 212 segments the plurality of claims based on the number or frequency of claims availed by age based segmentation, gender based segmentation, work type segmentation, disease based, financial information based, policy type etc. In another embodiment, the frequency based segmentor 212 segments the plurality of claims based on different attributes including age, gender, and work or based on predefined larger dimension set.

The time based segmentor 214 segments the plurality of claims based on the duration for which the claim was availed with respect to the policy type on multiple parameters like age, gender, work, type and so on. Upon segmentation, the time based segmentor 214 classifies the plurality of claims into two categories, for example, first category comprising claims that are taken for longer duration and second category comprising claims that are taken for shorter duration.

At block 306, determine risk associated with segments. In one embodiment, the EERR 132 is configured to determine the vulnerability level of the frequency based and time based segments. In one embodiment, the EERR 132 receives the frequency based and time based segments from the analytics module 130 and computes one or more high risk prone segments and degree of risk associated with a particular high risk prone segment. The EERR 132 computes the one or more high risk prone segments by adding dollar value to the frequency based and time based segments and determines the degree of risk associated with each frequency based and time based segments. Upon determining the degree of risk, the EERR 132 creates a Risk stack by ranking the segments in the order of risk degree. The EERR 132 also enables addition or removal of segments and real time creation of the risk stack upon addition or removal.

At block 308, perform risk profiling. In one embodiment, profiler 134 creates a segment based model and performs profiling of the customers based on the segment based model thus created. In one embodiment, the profiler 134 creates the segment based model based on the risk determined by the EERR 132. Upon creating the segment based model, the profiler 134 performs profiling of the customers. In one aspect, the profiler 134 creates one or more profiles of the customers based on segment and customer information. The profiler 134 also enables using multiple dimensions including medical, behavior, age, gender and so on and forecast profiling based on change in the multiple dimensions. In one exemplary scenario, when a new policy is provided to a customer, the profiler 132 performs real time profiling of the prospect customer and determines the degree of risk associated with the prospect customer. The profiler 134 further determines the premium value based on the degree risk determined for the prospect customer. Further, the profiler 134 enables comparison of one or more profiles based on different segments and determines one or more risk prone profiles based on comparison. The profiler 134 also determines one or more policy types that are favorable for one or more segments or customers based on the associated risk.

At block 310, predict financial impact. In one embodiment, crowing engine 136 predicts or forecasts the set of customers who are likely to avail the claim so as to provide a clear view of the financials to the insurer to determine the financial reserve in advance. In one embodiment, the crowing engine 136 creates a predictive model based on the frequency based and time based segments determined by the analytics module 130, the profiling of the customers by the EERR 132 and one or more parameters including age, gender, disease, behaviour, work industry, type of work, etc. Based on the predictive model thus created, the crowing engine 136 forecasts as to whether the customer is availing the claim or not and determines the list of customers who are likely to avail the claim. Further, the crowing engine 136 also determines the actual number of days for which the customer is likely to avail the claim based on already approved claim duration. Based on the predictive model and the forecast model along with actual number of days, the otter module 138 computes the debt and continuously monitors the risk and debit in a balance sheet. The crowing engine 136 also determines the areas of improvement where the debit index can be minimal.

The otter module 138 predicts or forecast debit on the claims been availed or is likely to be availed by the customers. In one embodiment, the otter module 138 determines the debt on the claims that are availed or likely to be availed based on the prediction or forecasting model created by the crowing engine 136. The otter module 138 also generates real time account summary reports of each account of the customers. The debt calculator 216 analyses a plurality of authenticated genuine policies and a plurality of present authenticated risk prone policies and determines actual debt incurring to the insurer. The debt forecaster 218 forecast and generates a report on the financial impact of the insurance company if the risk prone policies are approved. The debt predictor 220 predicts the feasible out of work scenarios which will influence the debts to the insurance company.

The visualization engine 142 enables real time visualization of end-to-end life cycle and process flow of the claim. In one embodiment, the visualization engine 142 enables claim processing and analyzes the customer segment based on one or more dimensions including disease, behavior and so on. The visualization engine 142 also validates the accuracy of the prediction and forecasting model for tuning and rebuilding the model upon detecting any accuracy error. Further, the visualization engine 142 performs claim prediction and forecasting and claim analysis based on the customer's historical data.

The scheduler 206 in the data adapter 128 considers all the predictions, forecasts of risk, debts as well the profiling of customers. Predictions, forecasts of debts of specific time are compared with the actuals and feedback is provided on the claim, policy for which prediction or forecast was different than actual of that policy and claim. Similar model is performed in profiling indicating the more risk prone segment was an actual more risk prone segment or not. This feedback is carried to the respective module which considers its analysis and changes weightage or ignores involvement of different dimensions like age, gender impacting a particular disease or parameter accordingly to self-learn in prediction and forecast of more accurate results.

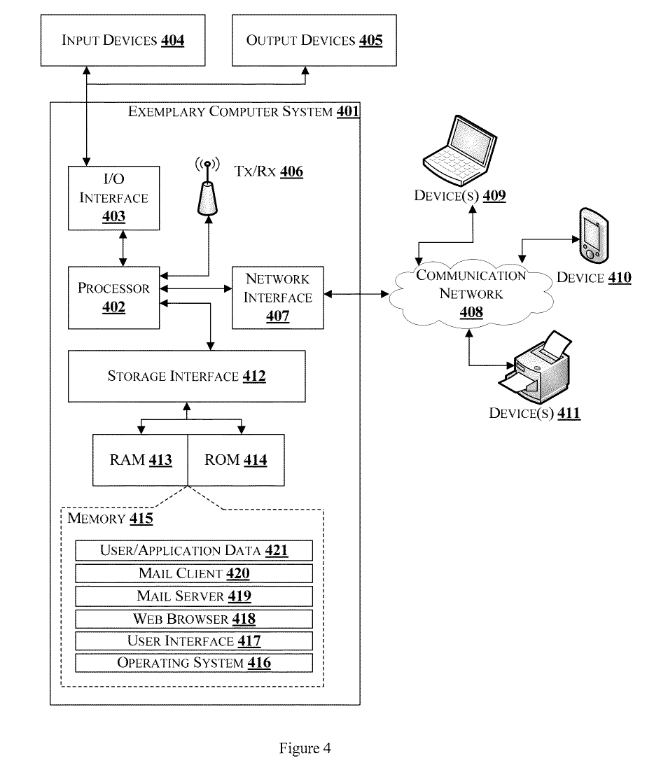

FIG. 4 is a block diagram of an exemplary computer system for implementing embodiments consistent with the present disclosure.

Variations of computer system 401 may be used for implementing all the computing systems that may be utilized to implement the features of the present disclosure. Computer system 401 may comprise a central processing unit (“CPU” or “processor”) 402. Processor 402 may comprise at least one data processor for executing program components for executing user- or system-generated requests. The processor may include specialized processing units such as integrated system (bus) controllers, memory management control units, floating point units, graphics processing units, digital signal processing units, etc. The processor 402 may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface 407 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 409, 410, and 411. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 4Error! Reference source not found.14, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 415 may store a collection of program or database components, including, without limitation, an operating system 4Error! Reference source not found.16, user interface application 4Error! Reference source not found.17, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 301 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As described above, the modules 110, amongst other things, include routines, programs, objects, components, and data structures, which perform particular tasks or implement particular abstract data types. The modules 110 may also be implemented as, signal processor(s), state machine(s), logic circuitries, and/or any other device or component that manipulate signals based on operational instructions. Further, the modules 110 can be implemented by one or more hardware components, by computer-readable instructions executed by a processing unit, or by a combination thereof.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

We claim:

1. A method for determining potential risk of an insurance claim on an insuree by an insurer, the method comprising:
receiving, by a processor of a risk determination system, a plurality of insurance claims associated with a plurality of insurees;
classifying, by the processor, the plurality of insurance claims into a plurality of segments based on an insuree profile associated with each of the plurality of insurees, wherein the insuree profile comprises at least medical data and behavioral data associated with each of the plurality of insurees; and
determining, by the processor, risk associated with the plurality of segments based on at least the medical data and behavioral data of the plurality of insurees.

2. The method as claimed in claim 1, wherein the insuree profile further comprises at least one of insuree data, policy information of the insuree, claim information of the insuree and family history information of the insuree, wherein the insuree data comprises at least one of age of the insuree, gender of the insuree, work industry of the insuree, interests of the insuree, and social media profile of the insuree.

3. The method as claimed in claim 1, wherein classifying the plurality of insurance claims into the plurality of segments comprising the steps of:
performing a frequency based segmentation by segmenting the insurance claims on the basis of at least one of age, gender, location, industry, disease particulars, genealogy and psychology of the plurality of insurees; and
performing a time based segmentation by segmenting the insurance claims on the basis of duration for which the insurance claims are availed based on age, gender, location, industry, disease particulars, genealogy and psychology of the plurality of insurees.

4. The method as claimed in claim 1, wherein determining risk associated with a potential insuree comprising the steps of:
matching a user profile of the potential insuree with the insuree profile associated with the plurality of segments; and
computing an insurance premium value for the potential insuree based on the risk associated with the potential insuree.

5. The method as claimed in claim 1, further comprising predicting a financial impact to the insurer based on the risk associated with the one or more segments.

6. The method as claimed in claim 1, further comprising predicting a probability of a potential insuree availing an insurance policy based on a profile of the potential insuree and insuree profiles of the plurality of insurees.

7. A risk determination system for determining potential risk of an insurance claim on an insuree by an insurer, comprising:
a processor; and
a memory disposed in communication with the processor and storing processor-executable instructions, the instructions comprising instructions to:
receive a plurality of insurance claims associated with a plurality of insurees;
classify the plurality of insurance claims into a plurality of segments based on an insuree profile associated with each of the plurality of insurees, wherein the insuree profile comprises medical data and behavioral data of an insuree; and
determine a risk factor associated with the one or more segments based at least on the medical data and behavioral data of the plurality of insurees.

8. The system as claimed in claim 7, wherein the insuree profile further comprises at least one of insuree data, policy information of the insuree, claim information of the insuree and family history information of the insuree.

9. The system as claimed in claim 7, wherein the insuree data comprises at least one of age of the insuree, gender of the insuree, work industry of the insuree, interests of the insuree, and social media profile of the insuree.

10. The system as claimed in claim 7, wherein the processor is configured to classify the plurality of insurance claims into a plurality of segments by preforming a frequency based segmentation and a time based segmentation.

11. The system as claimed in claim 10, wherein the processor is configured to perform the frequency based segmentation by segmenting the insurance claims on the basis of at least one of age, gender, location, industry, disease particulars, genealogy and psychology of the plurality of insurees.

12. The system as claimed in claim 10, wherein the processor is configured to perform the time based segmentation by segmenting the insurance claims on the basis of duration for which the insurance claims are availed based on age, gender, location, industry, disease particulars, genealogy and psychology of the plurality of insurees.

13. The system as claimed in claim 10, wherein the processor is further configured to determine risk associated with a potential insuree by matching a user profile of the potential insuree with insuree profiles associated with the plurality of segments.

14. The system as claimed in claim 13, wherein the processor is further configured to compute an insurance premium value for the potential insuree based on the risk associated with the potential insuree.

15. The system as claimed in claim 7, wherein the processor is further configured to predict a financial impact to the insurer based on the risk associated with the one or more segments.

16. The system as claimed in claim 7, wherein the processor is further configured to predict a probability of a potential insuree availing an insurance policy based on a profile of the potential insuree and insuree profiles of the plurality of insurees.

17. A non-transitory computer readable medium including instructions stored thereon that when processed by at least one processor cause a system to perform acts of:
receiving a plurality of insurance claims associated with a plurality of insurees;
classifying the plurality of insurance claims into a plurality of segments based on an insuree profile associated with each of the plurality of insurees, wherein the insuree profile comprises at least medical data and behavioral data associated with each of the plurality of insurees; and
determining risk associated with the plurality of segments based on at least the medical data and behavioral data of the plurality of insurees.

18. The medium as claimed in claim 17, wherein the instructions, on execution, cause the at least one processor to classify the plurality of insurance claims into the plurality of segments by the steps of:
performing a frequency based segmentation by segmenting the insurance claims on the basis of at least one of age, gender, location, industry, disease particulars, genealogy and psychology of the plurality of insurees; and
performing a time based segmentation by segmenting the insurance claims on the basis of duration for which the insurance claims are availed based on age, gender, location, industry, disease particulars, genealogy and psychology of the plurality of insurees.

19. The medium as claimed in claim 17, wherein the instructions, on execution, cause the at least one processor to determine risk associated with a potential insuree comprising the steps of:
matching a user profile of the potential insuree with the insuree profile associated with the plurality of segments; and
computing an insurance premium value for the potential insuree based on the risk associated with the potential insuree.

20. The medium as claimed in claim 17, wherein the instructions, on execution, cause the at least one processor to:
predict a financial impact to the insurer based on the risk associated with the one or more segments; and
predict a probability of a potential insuree availing an insurance policy based on a profile of the potential insuree and insuree profiles of the plurality of insurees.
